(19) United States
(12) Patent Application Publication
(10) Pub. No.: US 2008/0130174 A1
(43) Pub. Date: Jun. 5, 2008

(54) Fixing method, head support mechanism and information recording apparatus

(75) Inventor: Takeshi Ohwe, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/005,854

(22) Filed: Dec. 28, 2007

Related U.S. Application Data
(63) Continuation of application No. PCT/JP2005/012492, filed on Jul. 6, 2005.

(51) Int. Cl. G11B 5/48

(52) U.S. Cl. 360/240

(57) ABSTRACT

The present invention aims to accurately fix members together and includes: an arranging process in which a cylindrical section of a second member of which inner wall has a noncircular cross-sectional shape is inserted into a bore made in a first member and the second member is placed relative to the first member; an inserting process in which a rod-like jig of which cross-section has a noncircular shape that has the maximum external diameter larger than the minimum inside diameter in the cylindrical section of the second member is inserted into the cylindrical section of the second member; and a turning process that fixes the cylindrical section of the second member in the bore of the first member by turning the rod-like jig in the cylindrical section to forcedly widen the cylindrical section.

This is a continuation filed under 35 U.S.C. § 111(a), of International Application No. PCT/JP2005/012492 filed Jul. 6, 2005.

### TECHNICAL FIELD

The present invention relates to a method for fixing members together, a head support mechanism using the fixed members and an information recording apparatus.

### BACKGROUND ART

Recently, as computers have been widely used, a large volume of information has been routinely handled. Such information is generally recorded on information recording media as a large number of physical marks, and information recording apparatuses intervening between the marks on the information recording media and electrical reproduction recorded signals access the information.

As an apparatus representative of such information recording apparatuses, a magnetic disk drive has been known. The magnetic disk drive frequently includes two or more magnetic disks as information recording media to enlarge storage capacity. Such two or more magnetic disks are fixed to a common, rotary shaft so as to be spaced apart from each other in parallel, and driven by the rotary shaft to rotate. On front and back sides of the magnetic disk, information is recorded and accessed by a magnetic head that comes close to the front and back sides of the rotating, magnetic disk.

The magnetic head of the magnetic disk drive is so-called “floating head.” The magnetic disk drive has a built-in head support mechanism for supporting the magnetic head while making the magnetic head come close to a surface of the information recording media. The head support mechanism is integrated together by combining components such as a hard carriage arm machined from a metal block and a flexible load beam made of a stainless steel plate. When the components of the head support mechanism are combined, it is necessary to fix the magnetic head to the carriage arm while securing high accuracy in the final stage.

FIG. 1 shows a method for fixing components of a conventional head support mechanism together.

In the conventional fixing method, a head slider 1 integrally formed with a magnetic head is bonded to an end of a suspension 2, and the suspension 2 is fixed to a base plate 3 by, for example, welding. Further, a carriage arm 4 is fixed to an arm shaft 5 by, for example, integral molding (that is molded in one piece) or fastening. The base plate 3 has a cylindrical boss 3a, and the carriage arm 4 has a circular bore 4a. The boss 3a is inserted into the bore 4a, and a ball 6 having a diameter slightly larger than an inside diameter of the boss 3a is passed completely through the boss 3a to widen the diameter of the boss 3a, and thereby the boss 3a is caulked in the bore 4a of the carriage arm 4 (see, for example, Patent Document 1).

Patent Document 1: Japanese Patent Laid-Open No. 9-63219

### DISCLOSURE OF THE INVENTION

However, in such a conventional fixing method, upon caulking, a gap between the carriage arm and the base plate, or warping of the carriage arm or the base plate may be produced, and therefore, relative spacing between the magnetic head supported by the head support mechanism and a surface of the information recording media may be also changed irregularly. Such irregularity induces an information access error because a predetermined floating height of the head cannot be provided. Further, in an apparatus having a load and unload mechanism in which the magnetic head comes and goes between a surface of the information recording media and a retracted position away from the information recording media, the irregularity described above causes a decrease in reliability of a head position upon load and unload, and in the worst case, a device fault typified by a head crash in which the magnetic head is brought into contact with the surface of the information recording media. Furthermore, R/W error may also occur due to an extraordinary vibration caused by deformation of the head support mechanism.

An object of the present invention, in view of the circumstances described above, is to provide a method for accurately fixing members together, a head support mechanism providing high reliability of a head position, and an information recording apparatus providing high operational safety.

A fixing method of the present invention to achieve the object described above is a method for fixing a first member having a bore and a second member having a cylindrical section together,

the method including:

an arranging process in which the cylindrical section of the second member is inserted into the bore of the first member, and the second member is placed relative to the first member, an inner wall of the cylindrical section having a noncircular cross sectional shape;

an inserting process in which a rod-like jig is inserted into the cylindrical section of the second member, the rod-like jig having a noncircular shape in cross section that has the maximum external diameter larger than the minimum inside diameter in the cylindrical section of the second member; and

a turning process that fixes the cylindrical section of the second member in the bore of the first member by turning the rod-like jig in the cylindrical section and thereby forcedly widening the cylindrical section.

The inventors found from the study that, in the conventional fixing method shown in FIG. 1, force applied to the carriage arm 4 and the base plate 3 when the ball 6 passed through the boss 3a acted in the normal direction of FIG. 1 (along the direction in which the ball 6 moved), which caused, for example, warping. That is, on the side into which the ball 6 is inserted, force in the direction in which the boss 3a is pressed into the bore of the carriage arm 4 causes warping in the base plate 3 in the direction in which a part except the boss 3a is moved away from the carriage arm 4. Further, on the side from which the ball 6 goes outward, force in the direction in which the boss 3a is pushed out from the bore of the carriage arm 4 generates a gap between the carriage arm 4 and the base plate 3, and causes warping in the base plate 3 in the direction in which the part of the boss 3a is moved away from the carriage arm 4.

The present invention was made based on such detailed study, and realizes fixing a first member and a second member together each other without generating force acting on the first and second members in the direction in which a cylindrical section is taken out and put in. That is, a rod-like jig having a noncircular cross-sectional shape is inserted into the cylindrical section of which inner wall has a noncircular cross-sectional shape, and turned around, so that a part of the rod-like jig having the maximum external diameter abuts against a part of the cylindrical section having the minimum inside diameter to forcedly widen the cylindrical section. At this time, force acts on the first and second members along the rotational direction of the rod-like jig, and therefore force is not generated in the direction in which the cylindrical section is taken out and put in, and thereby the warping or the gap described above is not generated. Therefore, due to the present invention, the members can be accurately fixed together.

In the fixing method of the present invention, it is a preferable embodiment that the first member includes a through hole as the bore, the arranging process is a process in which a plurality of the second members are respectively positioned at both ends of the through hole, the inserting process is a process in which one rod-like jig is inserted into the cylindrical sections of the plurality of the second members positioned at the both ends of the through hole, and the turning process is a process in which the cylindrical sections of the plurality of the second members are concurrently and forcedly widened. Further, it is also a preferable embodiment that the arranging process is a process in which the two or more second members are respectively positioned on each of the two or more first members; the inserting process is a process in which one rod-like jig is inserted into the cylindrical sections of the two or more second members positioned on the two or more first members; and the turning process is a process in which the cylindrical sections of the two or more second members are concurrently and forcedly widened.

Due to the fixing method of these preferable embodiments, because the two or more second members can be fixed to one or more first members at once, higher workability is provided.

Applying the fixing method of the present invention to a head support mechanism provides an embodiment that the second member is a head support member having an extended, rod-like shape on which one end, a head accessing information recording media is supported adjacent to or in contact with a surface of the information recording media, and on which other end opposite to the one end, the cylindrical section is provided; and the first member is an arm member having an extended, rod-like shape on which one end, the bore described above is made, the arm member rotating around a rotary shaft present on the other end side opposite to the one end.

Further, in the fixing method of the present invention, the cylindrical section of the second member preferably has the same thickness at each position in the longitudinal direction of the cylindrical section. Accordingly, uniform caulking can be provided in the longitudinal direction of the cylindrical section.

Moreover, the fixing method of the present invention also has a preferable embodiment that the second member includes, as the cylindrical section described above, a cylindrical section in which a cross-section of an inner wall has a periodic shape in the circumferential direction. Accordingly, uniform caulking can be provided in the circumferential direction of the cylindrical section.

Further, in the fixing method of the present invention, the second member may include, as the cylindrical section described above, a cylindrical section in which a cross-section of an inner wall has a polygonal shape, and the second member may include, as the cylindrical section described above, a cylindrical section in which convexes and concaves are made in an inner wall.

Further, in the fixing method of the present invention, the rod-like jig described above may have a cross-sectional shape that is smaller than a cross-sectional shape of an inner wall of the cylindrical section and analogous to the cross-sectional shape of the inner wall, and the rod-like jig may have a shape that is uniformly spaced at each position in the circumferential direction of an inner wall relative to the cylindrical section when the rod-like jig is inserted into the cylindrical section.

The fixing method of the present invention includes a preferable one that the rod-like jig has more rigidness than that of the cylindrical section, and typically, the rod-like jig is preferably made of extra-high steel. Accordingly, wear of the rod-like jig can be reduced.

Further, in the fixing method of the present invention, the rod-like jig preferably has a thin film coated on a surface thereof, and also the second member preferably has a thin film coated on an inner wall of the cylindrical section.

In such preferable fixing methods, the thin film more preferably is a lubricative thin film, a thin metal film, or a thin film of titanium nitride.

Due to such preferable fixing methods, wear powder produced from wear between the rod-like jig and the cylindrical section can be prevented from generation.

A head support mechanism of the present invention to achieve the object described above includes: a head support member having an extended rod-like shape, on which one end a head accessing information recording media is supported adjacent to or in contact with a surface of the information recording media, and on which other end opposite to the one end a cylindrical section of which inner wall has a noncircular cross-sectional shape is provided; and an arm member having an extended rod-like shape on which one end, a bore is made, the arm member rotating around a rotary shaft present on the other end side opposite to the one end, in which the cylindrical section of the head support member is inserted into the bore of the arm member to widen the cylindrical section, so that the head support member is fixed to the arm member.

Owing to the head support mechanism of the present invention, the head support member can be accurately fixed to the arm member, providing high reliability of a head position.

An information recording apparatus of the present invention to achieve the object described above includes: a medium support member that supports information recording media; a head support member having an extended rod-like shape, on which one end a head accessing the information recording media is supported adjacent to or in contact with a surface of the information recording media, and on which other end opposite to the one end a cylindrical section of which inner wall has a noncircular, cross-sectional shape is provided; and an arm member having an extended rod-like shape, on which one end a bore is made, the arm member rotating around a rotary shaft present on the other end side opposite to the one end, in which the cylindrical section of the head support member is inserted into the bore of the arm member to widen the cylindrical section, so that the head support member is fixed to the arm member.

The information recording apparatus of the present invention includes the head support mechanism having high reliability of a head position, providing high operational safety.

In addition, only basic embodiments of the head support mechanism and the information recording apparatus of the present invention have been here described merely to omit duplication, but the head support mechanism and the information recording apparatus of the present invention may include not only the basic embodiments described above, but various embodiments corresponding to each embodiment of the fixing method described above.

As described above, the present invention can provide the method for accurately fixing members together, the head support mechanism having high reliability of a head position and the information recording apparatus having high operational safety.

### BRIEF DESCRIPTION OF THE DRAWINGS

FIG. 1 shows a method for fixing components of a conventional magnetic head support mechanism together.

FIG. 2 shows a magnetic disk drive corresponding to one embodiment of an information recording apparatus of the present invention.

FIG. 3 shows a detailed structure of a base plate.

FIG. 4 illustrates a fixing method of a head support mechanism.

FIG. 5 shows a first variation of a cross-sectional shape.

FIG. 6 shows a second variation of a cross-sectional shape.

FIG. 7 shows a third variation of a cross-sectional shape.

FIG. 8 shows a fourth variation of a cross-sectional shape.

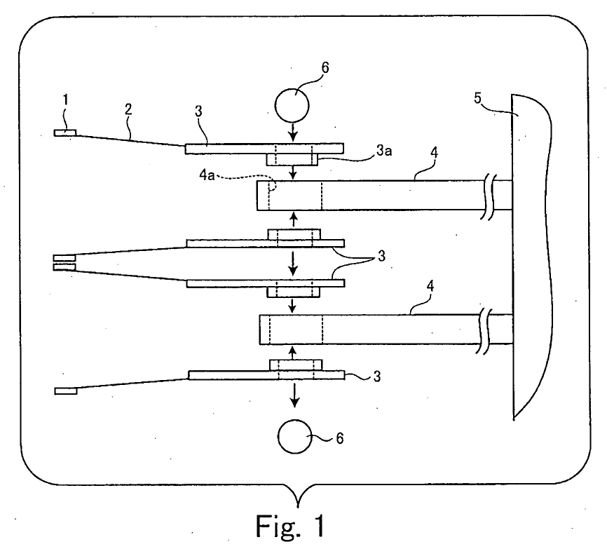

### BEST MODE FOR CARRYING OUT THE INVENTION

Now, embodiments of the present invention will be hereinafter described with reference to the accompanying drawings.

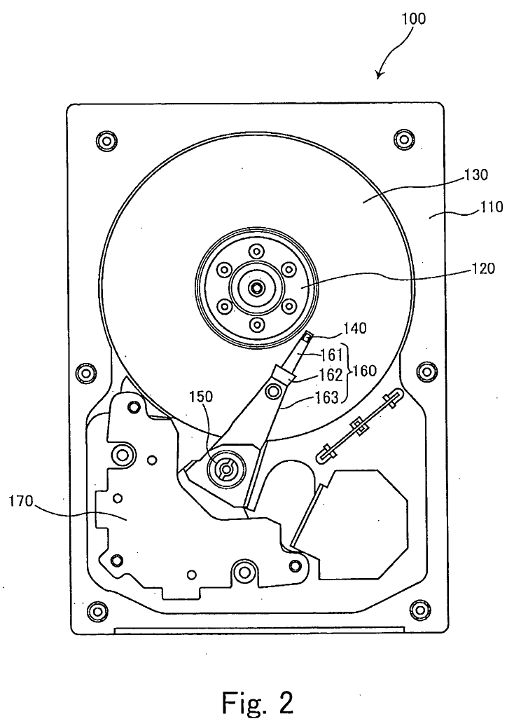

FIG. 2 shows a magnetic disk drive corresponding to one embodiment of an information recording apparatus of the present invention. This magnetic disk drive includes one embodiment of a head support mechanism of the present invention.

A housing 110 of the magnetic disk drive 100 shown in FIG. 2 contains: a rotary shaft 120; a magnetic disk 130 attached to the rotary shaft 120; a floating head slider 140 coming close to and opposed to a surface of the magnetic disk 130; a head support mechanism 160 on which end the floating head slider 140 is anchored, the head support mechanism 160 moving along a disk surface of the magnetic disk 130 around an arm shaft 150 as the central axis; and an actuator 170 for driving the head support mechanism 160. An inner space of the housing 110 is covered by a cover not shown. Here, the number of the magnetic disks 130 contained is multiple, and the multiple magnetic disks 130 are fixed to the one common, rotary shaft 120 and laid on one another spaced apart from each other.

The magnetic disk drive 100 records information on the magnetic disks 130 and reproduces the information recorded on the magnetic disks 130. Upon recording and reproducing the information, the head support mechanism 160 is driven by the actuator 170 composed of a magnetic circuit, and the floating head slider 140 is positioned at a desired track on the magnetic disks 130 that rotate due to driving of the rotary shaft 120. The floating head slider 140 has a magnetic head not shown, and the magnetic head comes close in turn to each area storing one bit lining up on each track of the magnetic disks 130, due to rotation of the magnetic disks 130, and accesses information of the area storing one bit by means of a magnetic field. Recording information in the high density makes a track distance narrower, and it is necessary for the magnetic head to accurately come close to each area storing one bit on the magnetic disks 130, so that high reliability of a head position is required for the head support mechanism 160.

The head support mechanism 160 in the present embodiment includes: a flexible load beam 161 on which end the floating head slider 140 is bonded, the load beam 161 being made of a stainless steel plate; a stainless base plate 162 to which the load beam 161 is welded; and a rigid carriage arm 163 machined from a metal block, in which the base plate 162 and the carriage arm 163 are fixed together by caulking.

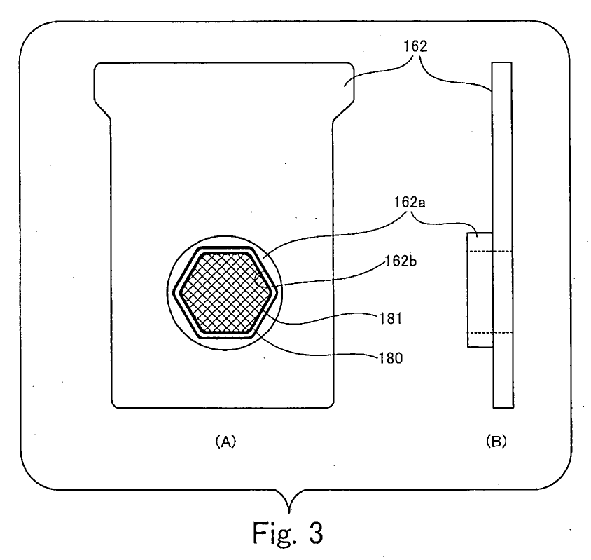

FIG. 3 shows a detailed structure of the base plate 162, and a part (A) of FIG. 3 is an elevation view and a part (B) of FIG. 3 is a side view.

In the base plate 162, a cylindrical boss 162a is provided, and an inner wall of the boss 162a has a hexagonal cross-sectional shape. A wall of the boss 162a has a uniform thickness at each position in the longitudinal direction of the boss.

As a jig for fixing such base plate 162 to the carriage arm, in the present embodiment, a rod-like jig 180 having a hexagonal cross-sectional shape is prepared. The rod-like jig 180 is made of extra-high steel, and a cross-sectional shape thereof is analogous to and slightly smaller than the cross-sectional shape of the inner wall of the boss 162a. Therefore, the maximum external diameter (the diameter of apexes of the hexagon) of the rod-like jig 180 is larger than the minimum inside diameter (the diameter of sides of the hexagon) of the boss 162a. Further, a surface of the rod-like jig 180 and the inner wall of the boss 162a are coated with titanium nitride (TiN) films 181 and 162b, which are lubricative metal films. In the present embodiment, the surface of the rod-like jig 180 and the inner wall of the boss 162a both are coated with the titanium nitride films, providing the rod-like jig 180 and the boss 162a with similar hardness.

The boss 162a of the base plate 162 is inserted into a through hole provided in the carriage arm 163 shown in FIG. 2 and caulked by the rod-like jig 180 as described below.

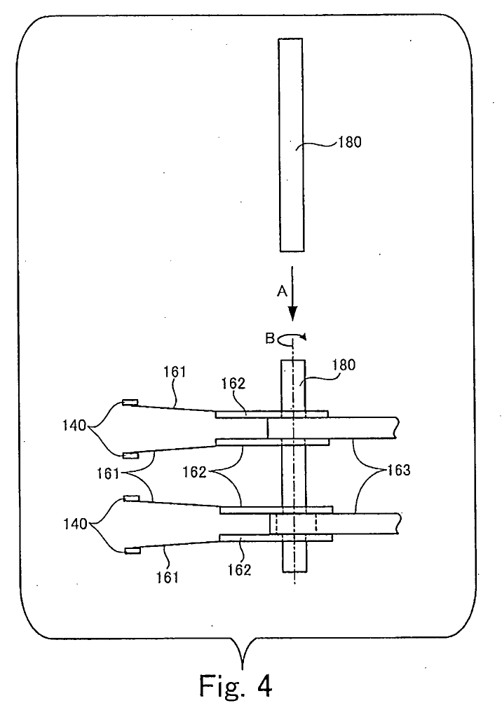

FIG. 4 illustrates a fixing method of the head support mechanism.

FIG. 4 shows that the floating head slider 140, the load beam 161, and the base plate 162 are integrated together by bonding or welding as shown in FIG. 2, and these are placed at a position to be fixed to the carriage arm 163, and the boss of the base plate 162 is inserted into the through hole of the carriage arm 163. Here, a combined member in which the floating head slider 140, the load beam 161, and the base plate 162 are integrated together corresponds to one example of the head support member in the present invention, and the carriage arm 163 corresponds to one example of the arm member in the present invention. Further, a process for arranging the combined member to the carriage arm 163 corresponds to one example of the arranging process in the present invention.

In the example shown in FIG. 4, the four (two pairs of) combined members are arranged to the two carriage arms 163. When the combined members are arranged in such a manner, a jig (not shown) holds down the pair of combined members placed on either side of one carriage arm 163 to further put the pair of combined members therebetween so that the arrangement is not irregularly changed. Then, the rod-like jig 180 is inserted completely through each boss of the four base plates 162 contained in the four combined members, in a manner shown by the arrow A. This process for inserting the rod-like jig 180 corresponds to one example of the inserting process in the present invention.

After the rod-like jig 180 is inserted, the rod-like jig 180 is turned around in a manner shown by the arrow B. This process for turning the rod-like jig corresponds to one example of the turning process in the present invention. Turning the rod-like jig 180 causes the apexes of the hexagon (see FIG. 3) of the rod-like jig 180 to forcedly widen the inner wall of each boss of the base plates 162. At this time, because the surface of the rod-like jig 180 and the inner walls of the bosses are coated with the titanium nitride films 181 and 162b as shown in FIG. 3, generation of wear powder is prevented due to friction between the rod-like jig 180 and the bosses.

Turning the rod-like jig 180 makes the diameter of each boss of the base plates 162 concurrently widen to caulk each boss in the through holes of the carriage arms 163, so that the base plates 162 are firmly fixed to the carriage arms 163. At this time, stress is applied to the base plates 162 and the carriage arm 163 in the direction around an axis of the rod-like jig 180, and therefore warping of the base plates 162 or a gap between the base plates 162 and the carriage arms 163 can be prevented from occurring, realizing accurate fixing. Also, multiple (here, two pairs, then four) base plates 162 can be concurrently fixed, providing high workability.

Hereinafter, variations of a cross-sectional shape in the inner wall of the boss and the rod-like jig will be described.

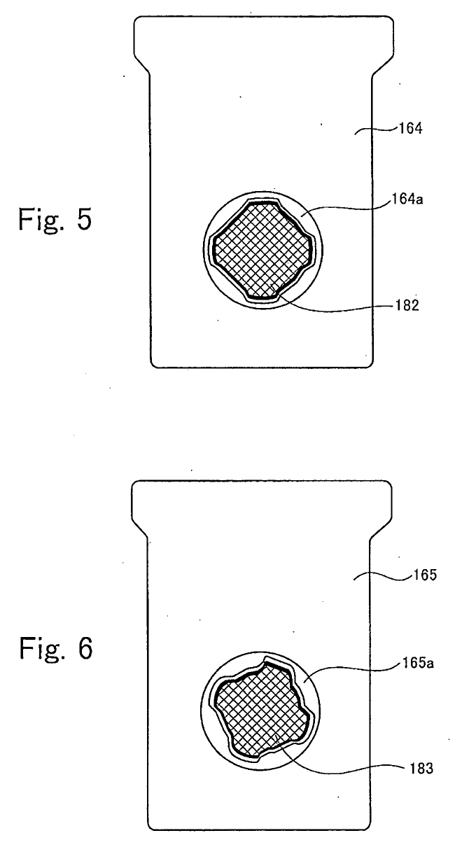

FIG. 5 shows a first variation of a cross-sectional shape.

In the variation shown in FIG. 5, an inner wall of a boss 164a of a base plate 164 has a cross-sectional shape with removed sharp edges and is approximately quadrangular, and a rod-like jig 182 has a shape having a constant distance from the approximately quadrangular shape.

FIG. 6 shows a second variation of a cross-sectional shape.

Also in the variation shown in FIG. 6, an inner wall of a boss 165a of a base plate 165 has an approximately quadrangular cross-sectional shape. However, in this variation, the inner wall of the boss 165a is cut out in a groove shape at about an apex of the approximate quadrangle. Further, a cross-sectional shape of a rod-like jig 183 has a constant distance from the cross-sectional shape of the inner wall of the boss 165a.

In the case of the variation of the cross-sectional shape shown in FIG. 6, compared to the case of the variation shown in FIG. 5, the rod-like jig 183 more widens the boss 165a, and it is thought to be suitable when more rigid fixing is required.

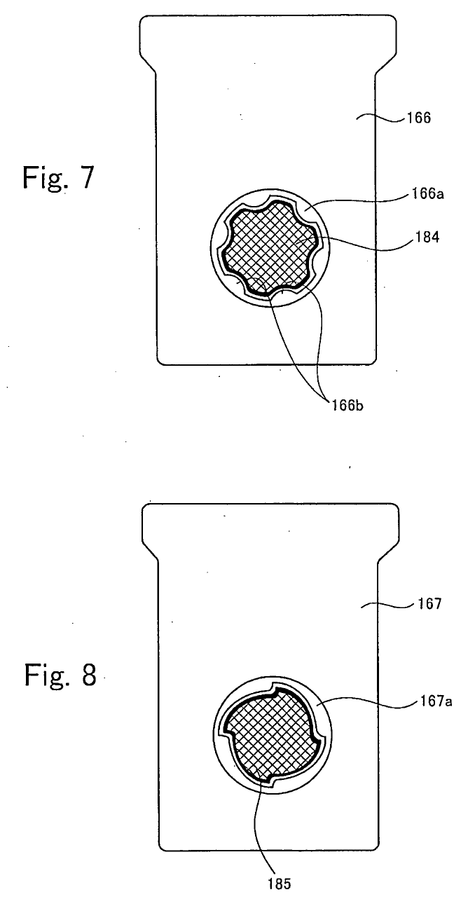

FIG. 7 shows a third variation of a cross-sectional shape.

In the variation shown in FIG. 7, six projections 166b are provided which are uniformly spaced on an inner wall of a boss 166a of a base plate 166, and a rod-like jig 184 has a cross-sectional shape having concave-convex portions corresponding to the projections 166b and grooves placed between the projections 166b.

FIG. 8 shows a fourth variation of a cross-sectional shape.

In the variation shown in FIG. 8, an inner wall of a boss 167a of a base plate 167 has a cross-sectional shape having asymmetry between the clockwise direction and the counterclockwise direction, and a rod-like jig 185 also has a similar, asymmetric cross-sectional shape. In the variation shown in FIG. 8, turning the rod-like jig 185 clockwise in FIG. 8 makes the boss 167a gradually and forcedly widen, and therefore small force applied for turning the rod-like jig 185 can achieve sufficiently firm fixing.

Owing to any of the variations described above, similarly to the embodiments described above, the base plate can be accurately fixed to the carriage arm. Therefore, the magnetic disk drive can turn out to be an apparatus having high safety and reliability because of high reliability of a head position in the head support mechanism.

In addition, in the embodiments described above, the magnetic disk drive has been described as one embodiment of the information recording apparatus of the present invention, but the information recording apparatus of the present invention may be an information recording apparatus using a magneto-optical disk.

Further, in the description above, the inner surface of the boss and the surface of the rod-like jig both are coated, but only any one of them may be coated in the present invention.

Also, materials of the base plate, the rod-like jig, and the coating film described above are only one example, and other materials may be employed to the present invention.

Further, in the description above, the member having the through hole has been described as one example of the first member or the arm member in the present invention, but the first member and the arm member in the present invention may be a member having a hole that does not pass completely through to the other side.

Also, in the description above, as the variation of the cross-sectional shape in the inner wall of the boss and the rod-like jig, only the shape having rotational periodicity has been illustrated, but in the present invention, such rotational periodicity is preferable, but not essential.

What is claimed is:

1. A fixing method for a first member having a bore and a second member having a cylindrical section together,
the method comprising:
an arranging process in which the cylindrical section of the second member is inserted into the bore of the first member, and the second member is placed relative to the first member, an inner wall of the cylindrical section having a noncircular cross sectional shape;
an inserting process in which a rod-like jig is inserted into the cylindrical section of the second member, the rod-like jig having a noncircular shape in cross section that has the maximum external diameter larger than the minimum inside diameter in the cylindrical section of the second member; and
a turning process that fixes the cylindrical section of the second member in the bore of the first member by turning the rod-like jig in the cylindrical section and thereby forcedly widening the cylindrical section.

2. The fixing method according to claim 1, wherein
the first member includes a through hole as the bore,
the arranging process is a process in which a plurality of the second members are respectively positioned at both ends of the through hole,
the inserting process is a process in which one rod-like jig is inserted into the cylindrical sections of the plurality of the second members positioned at the both ends of the through hole, and
the turning process is a process in which the cylindrical sections of the plurality of the second members are concurrently and forcedly widened.

3. The fixing method according to claim 1, wherein
the arranging process is a process in which a plurality of the second members are respectively positioned on each of a plurality of the first members,
the inserting process is a process in which one rod-like jig is inserted into the cylindrical sections of the plurality of second members positioned on the plurality of first members, and
the turning process is a process in which the cylindrical sections of the plurality of second members are concurrently and forcedly widened.

4. The fixing method according to claim 1, wherein
the second member is a head support member having an extended rod-like shape, on which one end a head accessing information recording media is supported adjacent to or in contact with a surface of the information recording media, and on which other end opposite to the one end, the cylindrical section is provided, and
the first member is an arm member having an extended rod-like shape on which one end, the bore is made, the arm member rotating around a rotary shaft present on the other end side opposed to the one end.

5. The fixing method according to claim 1, wherein
the cylindrical section of the second member has the same thickness at each position in the longitudinal direction of the cylindrical section.

6. The fixing method according to claim 1, wherein
the second member includes, as the cylindrical section, a cylindrical section in which a cross-section of an inner wall has a periodic shape in the circumferential direction.

7. The fixing method according to claim 1, wherein
the second member includes, as the cylindrical section, a cylindrical section in which a cross-section of an inner wall has a polygonal shape.

8. The fixing method according to claim 1, wherein
the second member includes, as the cylindrical section, a cylindrical section in which convexes and concaves are made in an inner wall.

9. The fixing method according to claim 1, wherein
the rod-like jig has a cross-sectional shape that is smaller than a cross-sectional shape of an inner wall of the cylindrical section and analogous to the cross-sectional shape of the inner wall.

10. The fixing method according to claim 1, wherein
the rod-like jig has a shape that is uniformly spaced at each position in the circumferential direction relative to an inner wall of the cylindrical section when the rod-like jig is inserted into the cylindrical section.

11. The fixing method according to claim 1, wherein
the rod-like jig has more rigidness than that of the cylindrical section.

12. The fixing method according to claim 1, wherein
the rod-like jig is made of extra-high steel.

13. The fixing method according to claim 1, wherein
the rod-like jig has a thin film coated on a surface thereof.

14. The fixing method according to claim 1, wherein
the second member has a thin film coated on an inner wall of the cylindrical section.

15. The fixing method according to claim 13, wherein the thin film is a lubricative thin film.

16. The fixing method according to claim 13, wherein the thin film is a thin metal film.

17. The fixing method according to claim 13, wherein the thin film is a thin film of titanium nitride.

18. A head support mechanism, comprising:
a head support member having an extended rod-like shape on which one end, a head accessing information recording media is supported adjacent to or in contact with a surface of the information recording media, and on which other end opposed to the one end, a cylindrical section of which inner wall has a noncircular, cross-sectional shape is provided; and
an arm member having an extended rod-like shape on which one end, a bore is made, the arm member rotating around a rotary shaft present on the other end side opposed to the one end, wherein
the cylindrical section of the head support member is inserted into the bore of the arm member to widen the cylindrical section, so that the head support member is fixed to the arm member.

19. An information recording apparatus, comprising:
a medium support member that supports information recording media;
a head support member having an extended rod-like shape on which one end, a head accessing the information recording media is supported adjacent to or in contact with a surface of the information recording media, and on which other end opposed to the one end, a cylindrical section of which inner wall has a noncircular, cross-sectional shape is provided; and
an arm member having an extended rod-like shape on which one end, a bore is made, the arm member rotating around a rotary shaft present on the other end side opposed to the one end, wherein
the cylindrical section of the head support member is inserted into the bore of the arm member to widen the cylindrical section, so that the head support member is fixed to the arm member.
